(19) United States
(12) Patent Application Publication
(10) Pub. No.: US 2026/0174527 A1
(43) Pub. Date: Jun. 25, 2026

(54) THREE-DIMENSIONAL SCANNING METHOD, APPARATUS SYSTEM, DEVICE AND MEDIUM

(71) Applicant: Shining 3D Tech Co., Ltd., Zhejiang (CN)

(72) Inventors: Chao MA, Zhejiang (CN); Xiaojun CHEN, Zhejiang (CN); Huiquan ZHANG, Zhejiang (CN)

(73) Assignee: Shining 3D Tech Co., Ltd., Zhejiang (CN)

(21) Appl. No.: 19/126,490

(22) PCT Filed: Nov. 1, 2023
(86) PCT No.: PCT/CN2023/129172

§ 371 Date: May 1, 2025

(30) Foreign Application Priority Data
Nov. 4, 2022 (CN) 202211374765.2

(51) Int. Cl. A61C 9/00; G06T 17/00; G06V 10/10; G06V 40/16

(52) U.S. Cl. CPC A61C 9/0053; G06T 17/00; G06V 10/16; G06V 40/161

(57) ABSTRACT

A three-dimensional scanning method, apparatus and system, and a device and a medium are provided. The system includes: a three-dimensional scanning apparatus, a service end, and a plurality of display terminals. The service end is separately connected to the three-dimensional scanning apparatus and each of the display terminals. Each of the display terminals is arranged at a target position. Anyone of the display terminals is configured to send a three-dimensional scanning request to the service end. The service end is configured to send a three-dimensional scanning instruction to the three-dimensional scanning apparatus based on the three-dimensional scanning request. The three-dimensional scanning apparatus is configured to perform scanning based on the three-dimensional scanning instruction to obtain three-dimensional scanning data. and send the three-dimensional scanning data to the service end.

### CROSS-REFERENCE TO RELATED APPLICATIONS

This application is a National Stage Entry under 35 U.S.C. § 371 of PCT International Application No. PCT/CN2023/129172 filed on Nov. 1, 2023, which The present disclosure claims priority to Chinese Patent Application No. 202211374765.2 filed to the China National Intellectual Property Administration on Nov. 4, 2022 and entitled “Three-Dimensional Scanning Method, Apparatus, System, Device and Medium”, the entire disclosure of each of which is hereby incorporated by reference.

### TECHNICAL FIELD

The present disclosure relates to the technical field of data processing, and in particular, to a three-dimensional scanning method, apparatus and system, and a device and a medium.

### BACKGROUND

In the related art, a three-dimensional data acquisition device of a dental clinic generally includes an intraoral scanner, a facial scanner, an extraoral scanner, etc. Each of the scanners is provided with a set of related accessories and devices for acquisition, such that each scanner, when used individually, has many accessories scattered throughout the clinic.

And the three-dimensional scanning devices are each provided with a computer and accessories, etc., and a dental chair needs to be provided with a set of three-dimensional scanning apparatuses.

### SUMMARY

The present disclosure provides a three-dimensional scanning method, apparatus, system, a device and a medium.

In a first aspect, some embodiments of the present disclosure provide a three-dimensional scanning method, including: a three-dimensional scanning apparatus, a service end, and a plurality of display terminals, where the service end is separately connected to the three-dimensional scanning apparatus and each of the display terminals, and each of the display terminals is arranged at a target position.

Any one of the display terminals is configured to send a three-dimensional scanning request to the service end.

The service end is configured to send a three-dimensional scanning instruction to the three-dimensional scanning apparatus based on the three-dimensional scanning request.

The three-dimensional scanning apparatus is configured to perform scanning based on the three-dimensional scanning instruction to obtain three-dimensional scanning data, and send the three-dimensional scanning data to the service end.

The service end is further configured to process the three-dimensional scanning data to obtain a target scanning result, and send the target scanning result to the display terminal.

The display terminal is further configured to display the target scanning result.

In a second aspect, some embodiments of the present disclosure further provide a three-dimensional scanning method. The method includes the following operations.

A three-dimensional scanning request sent by any one of display terminals is received.

A three-dimensional scanning instruction is sent to a three-dimensional scanning apparatus based on the three-dimensional scanning request.

Three-dimensional scanning data sent by the three-dimensional scanning apparatus is received.

The three-dimensional scanning data is processed to obtain a target scanning result, and sending the target scanning result to the display terminal for display.

In a third aspect, some embodiments of the present disclosure further provide a three-dimensional scanning apparatus. The apparatus includes a first receiving component, a sending component, a second receiving component, and a processing component.

The first receiving component is configured to receive a three-dimensional scanning request sent by any one of display terminals.

The sending component is configured to send a three-dimensional scanning instruction to a three-dimensional scanning apparatus based on the three-dimensional scanning request.

The second receiving component is configured to receive three-dimensional scanning data sent by the three-dimensional scanning apparatus.

The processing component is configured to process the three-dimensional scanning data to obtain a target scanning result, and send the target scanning result to the display terminal for display.

In a fourth aspect, some embodiments of the present disclosure further provide an electronic device. The electronic device includes: a processor; and a memory configured to store an instruction executable by the processor. The processor is configured to read the executable instruction from the memory, and execute the instruction to implement the three-dimensional scanning method provided in some embodiments of the present disclosure.

In a fifth aspect, some embodiments of the present disclosure further provide a non-transitory computer-readable storage medium. The storage medium stores a computer program. The computer program is configured to execute the three-dimensional scanning method provided in some embodiments of the present disclosure.

It should be understood that, the above general description and the following detailed description are merely exemplary and explanatory, and cannot limit the present disclosure.

### BRIEF DESCRIPTION OF FIGURES

Drawings are incorporated into the specification and constitute a part of the specification. The drawings illustrate embodiments in accordance with the present disclosure and serve to understand the principles of the present disclosure together with the specification.

In order to more clearly illustrate some embodiments of the present disclosure or the technical solutions in the related art, the drawings used in the description of some embodiments or the related art will be briefly described below. It is apparent that other drawings can be obtained from those skilled in the art according to these drawings without any creative work.

FIG. 1 is a schematic flowchart of a three-dimensional scanning method according to some embodiments of the present disclosure.

FIG. 2 is a schematic flowchart of another three-dimensional scanning method according to some embodiments of the present disclosure.

FIG. 3 is a schematic structural diagram of a three-dimensional scanning apparatus according to some embodiments of the present disclosure.

FIG. 4 is a schematic structural diagram of an electronic device according to embodiments of the present disclosure.

### DETAILED DESCRIPTION

In order to make objectives, technical solutions, and advantages of embodiments of the present disclosure clearer, the technical solutions in some embodiments of the present disclosure will be clearly and completely described below. It is apparent that the described embodiments are only part of some embodiments of the present disclosure, not all some embodiments. Based on some embodiments in the present disclosure, all other embodiments obtained by those of ordinary skill in the art without creative work shall fall within the protection scope of the present disclosure.

A three-dimensional scanning system of some embodiments of the present disclosure reduces the spatial movement of a scanner system and facilitates on-demand use in the clinic. One three-dimensional scanning apparatus (e.g., an intraoral scanner) supporting wireless scanning and one service end (e.g., a computer) are only required in the clinic, a plurality of display terminals are supported to be allocated to a target position corresponding to each dental chair, and the plurality of display terminals are switched randomly to meet requirements of three-dimensional scanning and acquisition functions of the plurality of dental chairs for on-demand use. In combination with a usage frequency scenario of the three-dimensional scanning apparatus, the waste of idle and wasteful resources caused by the procurement of a plurality of scanner systems due to the needs of the plurality of dental chairs in the same clinic, such that procurement costs are reduced, and the timeliness of the plurality of dental chairs using three-dimensional scanning is also met.

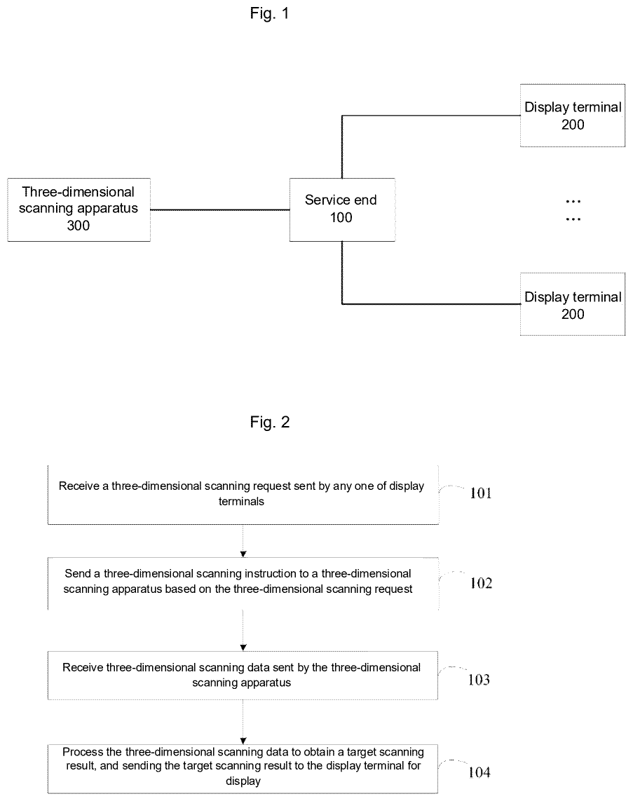

FIG. 1 is a schematic structural diagram of a three-dimensional scanning system according to some embodiments of the present disclosure. As shown in FIG. 1, the three-dimensional scanning system includes a three-dimensional scanning apparatus 300, a service end 100, and a plurality of display terminals 200.

The service end 100 is separately connected to the three-dimensional scanning apparatus 300 and each of the display terminals 200, and each of the display terminals 200 is arranged at a target position. The target position is selected and set according to an application scenario.

Any one of the display terminals 200 is configured to send a three-dimensional scanning request to the service end 100.

The service end 100 is configured to send a three-dimensional scanning instruction to the three-dimensional scanning apparatus 300 based on the three-dimensional scanning request.

The three-dimensional scanning apparatus 300 is configured to perform scanning based on the three-dimensional scanning instruction to obtain three-dimensional scanning data, and send the three-dimensional scanning data to the service end 100.

The service end 100 is further configured to process the three-dimensional scanning data to obtain a target scanning result, and send the target scanning result to the display terminal 200.

The display terminal 200 is further configured to display the target scanning result.

The three-dimensional scanning apparatus 300, for example, is an intraoral scanner, a facial scanner, or the like. Devices for acquiring three-dimensional data of teeth and gums inside an oral cavity generally include the intraoral scanner, which is also referred to as an oral digital impression instrument. The intraoral scanner may directly acquire three-dimensional morphology data of the teeth or gums, and is directly configured to process and repair the teeth to improve visit efficiency, so as to reduce accumulated errors caused by data conversion during a traditional processing flow. The intraoral scanner is a device that uses a probing-type optical scanning head to perform direct scanning in the oral cavity of a patient, so as to acquire three-dimensional morphology and color texture information of surfaces of hard and soft tissue such as teeth, gums, mucous membranes, etc. in the oral cavity. One usage of the device is to use active structured light triangulation imaging principle, an active light pattern is projected by using a digital projection system, and a camera acquisition system acquires the pattern, then performs three-dimensional reconstruction and splicing through algorithm processing.

Facial appearance is often very complementary to oral diagnosis and treatment. The facial scanner directly acquires three-dimensional morphology data and texture information of facial features through an optical imaging principle. The information is integrated into a Digital Smile Design (DSD) working flow through three-dimensional facial scanning, so as to replace an original two-dimensional picture, which becomes a mainstream technology for facial data acquisition and oral and maxillofacial diagnosis.

In some embodiments of the present disclosure, the entire set of service end 100 cooperates with the display terminal 200 systems to integrate the three-dimensional scanning apparatus 300 on a network platform, the three-dimensional scanning apparatus 300 (the intraoral scanner, the facial scanner, or the like) is connected to the service end 100, the service end 100 is used as a computation center, and the acquired three-dimensional data and texture information, etc. is distributed to each display terminal 200 via a network.

In some embodiments of the present disclosure, the three-dimensional scanning apparatus 300 establishes a wireless connection with the service end 100. The three-dimensional scanning apparatus 300 may be moved randomly inside the clinic, thereby meeting requirements of a plurality of dental chairs for on-demand use.

In some embodiments of the present disclosure, each display terminal 200 and the service end 100 are connected via the network, which may be connected in a wireless or wired manner.

The three-dimensional scanning apparatus 300 includes a scanner, and the number of the scanners may be 1, 2, 3, 4, etc. The scanner may be an intraoral scanner, a facial scanner, an ear scanner, a body scanner, or an extraoral scanner etc.; and the scanner may be a handheld scanner or a fixed scanner.

In some embodiments of the present disclosure, the three-dimensional scanning apparatus 300 includes two different scanners. The two different scanners are configured to perform scanning based on the three-dimensional scanning instruction to obtain first scanning data and second scanning data, and send the first scanning data and the second scanning data to the service end 100. The service end 100 is further configured to register the first scanning data and the second scanning data corresponding to a common feature area to a same world coordinate system for splicing, and performing three-dimensional reconstruction on the spliced data to obtain the target scanning result.

For example, the two different scanners are the intraoral scanner and the facial scanner. The intraoral scanner is configured to acquire tooth data in the mouth of a user. The facial scanner is configured to acquire facial data of the user. The tooth data and the facial data corresponding to the common feature area are registered to the same world coordinate system for splicing, and three-dimensional reconstruction is performed on the spliced data to obtain the target scanning result.

The two different scanners may be arranged separately, or may also be fixedly connected together. The two different scanners may be wired or wireless.

Alternatively, the acquisition devices such as the intraoral scanner, the facial scanner, and the like are connected to the service end 100 in a wired or wireless manner. When the display terminal 200 requests a scanning task, the acquisition device connected to the service end 100 may be selected randomly for data acquisition. When the service end 100 identifies the acquired data that is requested by the same display terminal 200 user, a splicing algorithm is used for registering, data of the common feature area is registered to the same world coordinate system, and the display terminal 200 may real-time display multisource data for communication and real-time viewing.

In some embodiments of the present disclosure, when the three-dimensional scanning request is received, whether there is a responding display terminal 200 is determined; and when there is a responding display terminal 200, response to the three-dimensional scanning request is refused.

Alternatively, the display terminal 200 is a device that is visible to the user and may be operated and controlled by the user. A distribution instruction of the service end 100 is requested by the user according to requirements. Other display terminals 200 cannot acquire the distribution of the service end 100 when the user is in use, thereby avoiding interference in the use of the display terminal 200 user.

In some embodiments of the present disclosure, the display terminal 200 is further configured to send the three-dimensional scanning request to the service end 100 at preset time intervals.

In some embodiments of the present disclosure, the display terminal 200 is further configured to receive a sending instruction, and send the three-dimensional scanning request to the service end 100 based on the sending instruction.

The request of the display terminal 200 may be set to be distributed automatically or may be set to be distributed in response.

In some embodiments of the present disclosure, the service end 100 is further configured to receive a switching request. The switching request includes a target display terminal identifier. The service end 100 is further configured to disconnect from a current display terminal based on the switching request, and be connected to a target display terminal corresponding to the target display terminal identifier.

Alternatively, the switching of the display terminals 200 at any moment may be realized, thereby distributing the data of the service end 100 to the display terminals 200 in switching. Therefore, the display terminals 200 are switched for real-time display, thereby further meeting the use requirements of the user.

In some embodiments of the present disclosure, the service end 100 is further configured to broadcast data information comprising the target scanning result and a terminal address. The display terminal 200 is configured to compare the terminal addresses in the data information, and receive the target scanning result in case of a consistent comparison.

Alternatively, the data is sent between the service end 100 and the display terminal 200 by means of broadcasting. In the same sub-network, the service end 100 needs to send a data packet to the display terminal 200, and the data packet includes the terminal address of a receiver, such as a local area network address. During sending, the service end 100 sends the data by means of broadcasting. In this case, other display terminals 200 in the same sub-network also receive the data packet. Then all the display terminals 200 received the data packet take out the local area network address of the data packet, compare same with their own local area networks, receive the data packet if the local area network addresses are the same, otherwise, discard the data packet.

To sum up, the three-dimensional scanning solution provided in some embodiments of the present disclosure includes: the three-dimensional scanning apparatus, the service end, and the plurality of display terminals. The service end is separately connected to the three-dimensional scanning apparatus and each of the display terminals. Each of the display terminals is arranged at the target position. Any one of the display terminals is configured to send the three-dimensional scanning request to the service end at preset time intervals. The service end is configured to send the three-dimensional scanning instruction to the three-dimensional scanning apparatus based on the three-dimensional scanning request. The three-dimensional scanning apparatus three-dimensional scanning instruction to obtain three-dimensional scanning data, and send the three-dimensional scanning data to the service end. The service end is further configured to process the three-dimensional scanning data to obtain the target scanning result, and send the target scanning result to the display terminals. The display terminal is further configured to display the target scanning result. By using the above technical solution, the sharing of the three-dimensional scanning apparatus by the plurality of display terminals can be implemented with a low cost, and the timeliness of three-dimensional scanning used by a plurality of dental chairs may be met while the costs are reduced.

FIG. 2 is a schematic flowchart of a three-dimensional scanning method according to some embodiments of the present disclosure. The method may be executed by a three-dimensional scanning apparatus. The apparatus may be implemented by using software and/or hardware, and may generally be integrated in an electronic device. As shown in FIG. 1, the method is applied to the service end 100, and includes the following steps.
At S101, a three-dimensional scanning request sent by any one of display terminals is received.
At S102, a three-dimensional scanning instruction is sent to a three-dimensional scanning apparatus based on the three-dimensional scanning request.
At S103, three-dimensional scanning data sent by the three-dimensional scanning apparatus is received.
At S104, the three-dimensional scanning data is processed to obtain a target scanning result, and sending the target scanning result to the display terminal for display.

It is to be noted that, the three-dimensional scanning method of the embodiment of the present disclosure corresponds to the foregoing three-dimensional scanning system, and details are referred to description of the foregoing embodiments, which are not described in detail herein again.

For example, a user operates the display terminal corresponding to a target position 1 such as a No. 1 dental chair to send the three-dimensional scanning request to the service end at preset time intervals. The service end then receives the three-dimensional scanning request, for example, determining a three-dimensional scanning instruction is that an intraoral three-dimensional scanner 2 performs intraoral scanning, such that the three-dimensional scanning instruction is sent to the intraoral three-dimensional scanner 2 for intraoral scanning, so as to acquire three-dimensional scanning data to the service end, and the service end processes the three-dimensional scanning data, for example, three-dimensional reconstruction and the like, so as to obtain the target scanning result and send the target scanning result to display terminal corresponding to the No. 1 dental chair for display. Therefore, the spatial movement of a scanner system is reduced, and on-demand use in the clinic is realized, and the plurality of dental chairs share one three-dimensional scanner at a low cost.

In the three-dimensional scanning solution provided in some embodiments of the present disclosure, the three-dimensional scanning request sent by any one of display terminals is received, the three-dimensional scanning instruction is sent to the three-dimensional scanning apparatus based on the three-dimensional scanning request., the three-dimensional scanning data sent by the three-dimensional scanning apparatus is received, and the three-dimensional scanning data is processed to obtain the target scanning result, and sending the target scanning result to the display terminal for display. By using the above technical solution, the sharing of the three-dimensional scanning apparatus by the plurality of display terminals can be implemented with a low cost, and the timeliness of three-dimensional scanning used by a plurality of dental chairs may be met while the costs are reduced.

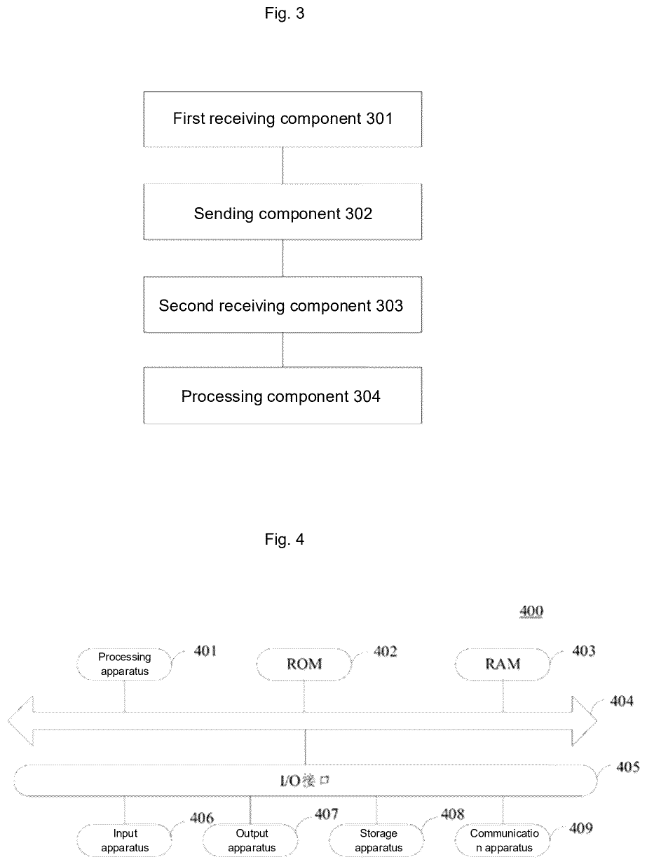

FIG. 3 is a schematic structural diagram of a three-dimensional scanning apparatus according to embodiments of the present disclosure. The apparatus may be implemented by using software and/or hardware, and may generally be integrated in an electronic device. As shown in FIG. 3, the apparatus includes a first receiving component, a sending component, a second receiving component, and a processing component.

The first receiving component 301 is configured to receive a three-dimensional scanning request sent by any one of display terminals.

The sending component 302 is configured to send a three-dimensional scanning instruction to a three-dimensional scanning apparatus based on the three-dimensional scanning request.

The second receiving component 303 is configured to receive three-dimensional scanning data sent by the three-dimensional scanning apparatus.

The processing component 304 is configured to process the three-dimensional scanning data to obtain a target scanning result, and send the target scanning result to the display terminal for display.

The three-dimensional scanning apparatus provided in some embodiments of the present disclosure may execute the three-dimensional scanning method provided in any embodiment of the present disclosure, and thus has corresponding functional components for performing the method and corresponding beneficial effects.

Some embodiments of the present disclosure further provides a computer program product, including a computer program/instruction. The computer program/instruction, when being executed by a processor, implements the three-dimensional scanning provided in any embodiment of the present disclosure.

FIG. 4 is a schematic structural diagram of an electronic device according to embodiments of the present disclosure. Referring to FIG. 4 below, the schematic structural diagram suitable for implementing the electronic device 400 in some embodiments of the present disclosure is shown. The electronic device 400 in some embodiments of the present disclosure may include, but is not limited to, mobile terminals such as cell phones, notebook computers, digital broadcast receivers, Personal Digital Assistant (PDA), tablet computers (PADs), Portable Multimedia Players (PMPs), vehicle terminals (e.g., vehicle navigation terminals), and the like, as well as fixed terminals such as digital TVs, desktop computers, and the like. The electronic device shown in FIG. 4 is only an example, and should not impose any limitations on the functionality and scope of use of embodiments of the present disclosure.

As shown in FIG. 4, the electronic device 400 may include a processing apparatus 401 (e.g., central processing unit, graphics processing unit, or the like), which may perform various appropriate actions and processing operations according to a program stored in a Read-Only Memory (ROM) 402 or a computer program loaded from a storage apparatus 408 into a Random Access Memory (RAM) 403. In the RAM 403, various programs and data required for the operation of the electronic device 400 may also be stored. The processing apparatus 401, the ROM 402, and the RAM 403 are connected to each other via a bus 404. An Input/Output (I/O) interface 405 is also connected to the bus 404.

Generally, the following apparatuses may be connected to the I/O interface 405: an input apparatus 406 including, for example, a touch screen, a touch pad, a keyboard, a mouse, a camera, a microphone, an accelerometer, a gyroscope, and the like; an output apparatus 407 including, for example, a Liquid Crystal Display (LCD), a loudspeaker, a vibrator, and the like; a storage apparatus 408 including, for example, a magnetic tape, a hard disk, and the like; and a communication apparatus 409. The communication apparatus 409 may allow the electronic device 400 to perform wireless or wire communication with other devices, so as to exchange data. Although FIG. 4 shows the electronic device 400 having various apparatuses, it should be understood that, it is not required to implement or have all of the shown apparatuses. More or fewer apparatuses may alternatively be implemented or possessed.

Alternatively, the process described above with reference to a flowchart may be implemented as a computer software program according to the disclosed embodiments of the present disclosure. For example, the disclosed embodiments of the present disclosure include a computer program product including a computer program carried on a non-transitory computer-readable medium, and the computer program includes a program code for executing the method shown in the flowchart. In such an embodiment, the computer program may be downloaded and installed from the network through the communication apparatus 409, or installed from the storage apparatus 408, or installed from the ROM 402. When the computer program is executed by the processing apparatus 401, the above functions defined in the three-dimensional scanning method in some embodiments of the present disclosure are executed.

It is to be noted that, the computer-readable medium shown in the present disclosure may be a computer-readable signal medium or a non-transitory computer-readable storage medium or any combination thereof. The non-transitory computer-readable storage medium, for example, may be, but not limited to, an electrical, magnetic, optical, electromagnetic, infrared, or semiconductor system, apparatus or device, or a combination of any of the above. More specific examples of the non-transitory computer-readable storage medium may include, but are not limited to, an electrical connection member including one or more wires, a portable computer disk, a hard disk, an RAM, an ROM, an Erasable Programmable Read-Only Memory (EPROM), a flash memory, optical fiber, a portable Compact Disc Read-Only Memory (CD-ROM), an optical storage device, a magnetic storage device, or any appropriate combination thereof. In the present disclosure, the non-transitory computer-readable storage medium may be any tangible medium that includes or stores a program. The program may be used by or in combination with an instruction execution system, an apparatus, or a device. In the present disclosure, the computer-readable signal medium may include a data signal that is propagated in a base band or propagated as a part of a carrier wave, which carries a computer-readable program code therein. The propagated data signal may adopt a plurality of forms including, but not limited to, an electromagnetic signal, an optical signal, or any suitable combination of the above. The computer-readable signal medium may also be any computer-readable medium other than the non-transitory computer-readable storage medium. The computer-readable signal medium may send, propagate or transmit the program that is used by or in combination with the instruction execution system, the apparatus, or the device. The program code in the computer-readable medium may be transmitted with any proper medium, including, but not limited to, a wire, an optical cable, Radio Frequency (RF), etc., or any proper combination thereof.

In some implementations, a client or a service end may communicate by using any currently known or future developed network protocol such as Hyper Text Transfer Protocol (HTTP) and may be interconnected with digital data communications (for example, communication networks) in any form or medium. Examples of a communication network include an LAN, a WAN, an inter-network (for example, the Internet), and an end-to-end network (for example, an ad hoc end-to-end network), as well as any currently known or future developed networks.

The computer-readable medium may be included in the electronic device, or may also be present separately and not fitted into the electronic device.

The above computer-readable medium carries one or more program. When the above one or more program are executed by the electronic device, the electronic device is configured to: receive a three-dimensional scanning request sent by any one of display terminals; send a three-dimensional scanning instruction to a three-dimensional scanning apparatus based on the three-dimensional scanning request; receive three-dimensional scanning data sent by the three-dimensional scanning apparatus; process the three-dimensional scanning data to obtain a target scanning result, and send the target scanning result to the display terminal for display.

The computer program code configured to execute operations in the present disclosure may be compiled by using one or more programming languages or a combination thereof. The programming languages include a programming language facing an object, such as Java, Smalltalk, and C++, and further include a conventional procedural programming language, such as “C” language, or similar programming languages. The program code may be completely executed in a computer of a user or partially executed in the computer of the user, executed as an independent software package, executed partially in the computer of the user and partially in a remote computer, or executed completely in the remote server or a service end. In a situation involving the remote computer, the remote computer may be connected to the user computer by using any type of network including a local area network (LAN) or a wide area network (WAN), or may be connected to an external computer (for example, connected to the external computer through the Internet by using an Internet service provider).

The flowcharts and block diagrams in the drawings illustrate probably implemented system architectures, functions, and operations of the system, method, and computer program product according to various embodiments of the present disclosure. On this aspect, each block in the flowcharts or block diagrams may represent a component, a program segment, or a portion of a code, which includes one or more executable instructions for implementing the specified logic functions. It is also to be noted that, in certain alternative implementations, the functions marked in the blocks may also be realized in a sequence different from those marked in the drawings. For example, two blocks shown in succession may, in fact, be executed substantially in parallel, and sometimes in a reverse sequence, depending upon the functionality involved. It is also to be noted that each block of the block diagrams and/or flowcharts and combinations of blocks in the block diagrams and/or flowcharts may be implemented by dedicated hardware-based systems that execute the specified functions or operations, or may be implemented in a combination of dedicated hardware and computer instructions.

The units described in some embodiments of the present disclosure may be implemented by means of software or hardware. The name of the unit does not in some cases constitute a limitation of the unit itself.

The functions described above herein may be executed, at least in part, by one or more hardware logic components. For example, without limitation, exemplary types of hardware logic components that may be used include: a Field Programmable Gate Array (FPGA), an Application-Specific Integrated Circuit (ASIC), an Application-Specific Standard Product (ASSP), systems-on-chip (SOC), a Complex Programmable Logic Device (CPLD), and the like.

In the context of the present disclosure, a machine-readable medium may be a tangible medium, which may include or store a program for being used by an instruction execution system, device, or apparatus or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, device, or apparatus, or any foregoing suitable combinations. More specific examples of the machine-readable storage medium may include electrical connections based on one or more wires, a portable computer disk, a hard disk, an RAM, an ROM, an Erasable Programmable Read-Only Memory (EPROM or flash memory), an optical fiber, a portable Compact Disk Read-Only Memory (CD-ROM), an optical storage device, a magnetic storage device, or any above suitable combinations.

According to one or more embodiments of the present disclosure, the present disclosure provides an electronic device, including: a processor; and a memory configured to store an instruction executable by the processor.

The processor is configured to read the executable instruction from the memory, and execute the instruction to implement any one of the three-dimensional scanning methods provided in the present disclosure.

According to one or more embodiments of the present disclosure, the present disclosure provides a non-transitory computer-readable storage medium. The storage medium stores a computer program. The computer program is configured to execute any one of the three-dimensional scanning methods provided in the present disclosure.

It is to be noted that, relational terms such as “first” and “second” are used merely to distinguish one entity or operation from another entity or operation herein, and do not necessarily require or imply the existence of any such actual relationship or order between these entities or operations. Furthermore, terms “comprise”, “include” or any other variants are intended to encompass non-exclusive inclusion, such that a process, a method, an article or a device including a series of elements not only include those elements, but also includes other elements not listed explicitly or includes intrinsic elements for the process, the method, the article, or the device. Without any further limitation, an element defined by the phrase “comprising one” does not exclude existence of other same elements in the process, the method, the article, or the device that includes the elements.

The above is merely the implementation of the present disclosure, to make those skilled in the art to understand or implement the present disclosure. It is apparent that those skilled in the art will make many modifications to these embodiments, the general principles defined in the present disclosure may be achieved in the other embodiments without departing from the spirit or essential attributes of the present disclosure. Therefore, the present disclosure will not be limited to some embodiments shown herein, but to conform to the maximum extent of principles and new features that are disclosed herein.

### INDUSTRIAL APPLICABILITY

According to the three-dimensional scanning solution provided in the present disclosure, the three-dimensional scanning apparatus can be shared by the plurality of display terminals at a low cost, and the timeliness of three-dimensional scanning used by a plurality of dental chairs may be met while the costs are reduced.

1. A three-dimensional scanning system, comprising: a three-dimensional scanning apparatus, a service end, and a plurality of display terminals, wherein the service end is separately connected to the three-dimensional scanning apparatus and each of the display terminals, and each of the display terminals is arranged at a target position;
any one of the display terminals is configured to send a three-dimensional scanning request to the service end;
the service end is configured to send a three-dimensional scanning instruction to the three-dimensional scanning apparatus based on the three-dimensional scanning request;
the three-dimensional scanning apparatus is configured to perform scanning based on the three-dimensional scanning instruction to obtain three-dimensional scanning data, and send the three-dimensional scanning data to the service end;
the service end is further configured to process the three-dimensional scanning data to obtain a target scanning result, and send the target scanning result to the display terminal; and
the display terminal is further configured to display the target scanning result.

2. The three-dimensional scanning system as claimed in claim 1, wherein the three-dimensional scanning apparatus comprises two different scanners;
the two different scanners are configured to perform scanning based on the three-dimensional scanning instruction to obtain first scanning data and second scanning data, and send the first scanning data and the second scanning data to the service end; and
the service end is further configured to register the first scanning data and the second scanning data corresponding to a common feature area to a same world coordinate system for splicing, and performing three-dimensional reconstruction on the spliced data to obtain the target scanning result.

3. The three-dimensional scanning system as claimed in claim 1, wherein the service end is further configured to:
when receiving the three-dimensional scanning request, determine whether there is a responding display terminal; and
in response to there is a responding display terminal, refuse to respond to the three-dimensional scanning request.

4. The three-dimensional scanning system as claimed in claim 1, wherein
the display terminal is further configured to send the three-dimensional scanning request to the service end at preset time intervals.

5. The three-dimensional scanning system as claimed in claim 1, wherein
the display terminal is further configured to receive a sending instruction, and send the three-dimensional scanning request to the service end based on the sending instruction.

6. The three-dimensional scanning system as claimed in claim 1, wherein
the service end is further configured to receive a switching request, wherein the switching request comprises a target display terminal identifier; and
the service end is further configured to disconnect from a current display terminal based on the switching request, and be connected to a target display terminal corresponding to the target display terminal identifier.

7. The three-dimensional scanning system as claimed in claim 1, wherein
the service end is further configured to broadcast data information comprising the target scanning result and a terminal address; and
the display terminal is configured to compare the terminal addresses in the data information, and receive the target scanning result in case of a consistent comparison.

8. A three-dimensional scanning method, applied to a service end, and comprising:
receiving a three-dimensional scanning request sent by any one of display terminals;
sending a three-dimensional scanning instruction to a three-dimensional scanning apparatus based on the three-dimensional scanning request;
receiving three-dimensional scanning data sent by the three-dimensional scanning apparatus; and
processing the three-dimensional scanning data to obtain a target scanning result, and sending the target scanning result to the display terminal for display.

9. (canceled)

10. An electronic device, comprising:
a processor, and
a memory configured to store a processor-executable instruction, wherein
the processor is configured to read the executable instruction from the memory and execute the instruction to implement:
receive a three-dimensional scanning request sent by any one of display terminals;
send a three-dimensional scanning instruction to a three-dimensional scanning apparatus based on the three-dimensional scanning request;
receive three-dimensional scanning data sent by the three-dimensional scanning apparatus; and
process the three-dimensional scanning data to obtain a target scanning result, and sending the target scanning result to the display terminal for display.

11. (canceled)

12. The three-dimensional scanning system as claimed in claim 2, wherein the two different scanners comprise intraoral scanner and facial scanner, the intraoral scanner is configured to acquire tooth data in the mouth of a user, and the facial scanner is configured to acquire facial data of the user.

13. The three-dimensional scanning system as claimed in claim 12, wherein the intraoral scanner is a device that uses a probing-type optical scanning head to perform direct scanning in the oral cavity of a patient.

14. The three-dimensional scanning system as claimed in claim 12, wherein the facial scanner is configured to directly acquires three-dimensional morphology data and texture information of facial features through an optical imaging principle.

15. The three-dimensional scanning method as claimed in claim 8, wherein the three-dimensional scanning apparatus comprises two different scanners, and the two different scanners are configured to perform scanning based on the three-dimensional scanning instruction to obtain first scanning data and second scanning data, and send the first scanning data and the second scanning data to the service end; the method further comprises:
registering the first scanning data and the second scanning data corresponding to a common feature area to a same world coordinate system for splicing, and performing three-dimensional reconstruction on the spliced data to obtain the target scanning result.

16. The three-dimensional scanning method as claimed in claim 8, wherein the method further comprises:
when receiving the three-dimensional scanning request, determining whether there is a responding display terminal; and
in response to there is a responding display terminal, refusing to respond to the three-dimensional scanning request.

17. The three-dimensional scanning method as claimed in claim 8, wherein the display terminal is further configured to send the three-dimensional scanning request to the service end at preset time intervals.

18. The three-dimensional scanning method as claimed in claim 8, the display terminal is further configured to receive a sending instruction, and send the three-dimensional scanning request to the service end based on the sending instruction.

19. The three-dimensional scanning method as claimed in claim 8, wherein the method further comprises:
receiving a switching request, wherein the switching request comprises a target display terminal identifier; and, disconnecting from a current display terminal based on the switching request, and be connected to a target display terminal corresponding to the target display terminal identifier.

20. The three-dimensional scanning method as claimed in claim 8, wherein the method further comprises:
broadcasting data information comprising the target scanning result and a terminal address, wherein the display terminal is configured to compare the terminal addresses in the data information, and receive the target scanning result in case of a consistent comparison.

21. The electronic device as claimed in claim 10, wherein the three-dimensional scanning apparatus comprises two different scanners, and the two different scanners are configured to perform scanning based on the three-dimensional scanning instruction to obtain first scanning data and second scanning data, and send the first scanning data and the second scanning data to the service end; the processor is further configured to:
register the first scanning data and the second scanning data corresponding to a common feature area to a same world coordinate system for splicing, and perform three-dimensional reconstruction on the spliced data to obtain the target scanning result.

22. The electronic device as claimed in claim 10, wherein the processor is further configured to:
when receiving the three-dimensional scanning request, determine whether there is a responding display terminal; and
in response to there is a responding display terminal, refuse to respond to the three-dimensional scanning request.
